(19) United States
(12) Patent Application Publication
(10) Pub. No.: US 2024/0119583 A1
(43) Pub. Date: Apr. 11, 2024

(54) INSPECTION SYSTEM FOR PRINT MEDIUM, CONTROL METHOD, AND STORAGE MEDIUM

(71) Applicant: CANON KABUSHIKI KAISHA, Tokyo (JP)

(72) Inventor: YUKI DAIKU, Chiba (JP)

(21) Appl. No.: 18/476,188

(22) Filed: Sep. 27, 2023

(30) Foreign Application Priority Data
Sep. 30, 2022 (JP) 2022-157627

(51) Int. Cl. G06T 7/00; G06T 7/33

(52) U.S. Cl. CPC G06T 7/001; G06T 7/337; G06T 2207/10008; G06T 2207/30144

(57) ABSTRACT

An inspection system includes an alignment unit that performs alignment between a reference image and an inspection image by sequentially using a plurality of ranges of interest different in size, and an inspection unit that inspects the reference image and the inspection image based on the alignment performed by the alignment unit.

### BACKGROUND

### Field of the Disclosure

The present disclosure relates to an inspection system capable of inspecting output results such as print products output in a print process, a method for controlling the inspection system, and a storage medium.

### Description of the Related Art

A print product output from a printing apparatus may have smudges due to, for example, color materials such as ink or toner adhering to unintended places. The print product may also have color losses because the color materials have not sufficiently adhered to places where an image is supposed to be formed and the colors appear lighter than intended at the places. Print defects such as smudges and color losses deteriorate the quality of the print product. In order to assure the quality of the print product, the print product is inspected for defects.

Visual inspection in which an inspector visually checks the print product for the presence or absence of defects requires a lot of time and cost. Thus, in recent years, there has been suggested an inspection system that automatically inspects the print product without depending on the visual check. Such an automatic inspection system uses an inspection method in which a printed image is scanned by a scanner and the scanned image is compared with a reference image. In the case of performing image inspection by comparing the scanned image and the reference image in this manner, it is important to perform high-accuracy alignment between the images because the alignment greatly affects the accuracy of the inspection.

As an alignment technique, there is known rigid alignment in which feature points are extracted and projection transformation is performed. However, the alignment by rigid transformation cannot correct local positional shifts due to irregular conveyance or stretch of paper. As a higher-accuracy alignment technique, there is known non-rigid alignment such as free-form deformations (FFD). Using non-rigid alignment enables correcting not only the shift and rotation of the image but also local scaling and local positional shifts. This achieves higher-accuracy alignment than the alignment by rigid transformation.

In the free-form alignment, a plurality of control points for controlling the shape of an image is arranged in a grid form on the image, and each of the control points is moved to deform the image. In the free-form alignment, to deform an inspection target image to align with a reference image, errors in the inspection target image are calculated and the positions of the control points are updated sequentially in directions where the errors become minimum.

Japanese Patent Application Laid-Open No. 2014-108349 discusses a technique for performing accurate, high-speed alignment using non-rigid alignment.

However, with the conventional alignment technique, if the pattern of an inspection target image and the pattern of a reference image do not overlap each other at the initial stage of alignment due to the degree of the shifts and the size of the pattern, the directions of the shifts may not be able to be calculated, so that the accuracy of the alignment may be lowered.

### SUMMARY

The present disclosure provides for improving accuracy of inspection of output results in a print process.

The present disclosure also provides a mechanism that enables alignment between a reference image and an inspection target image even if it is difficult to use a pattern or characters for the alignment between the images.

According to an aspect of the present disclosure, an inspection system that inspects an inspection image using a reference image includes an alignment unit configured to perform alignment between the reference image and the inspection image by sequentially using a plurality of ranges of interest that are different in size, and an inspection unit configured to inspect the reference image and the inspection image based on the alignment performed by the alignment unit.

Further features of the present disclosure will become apparent from the following description of embodiments with reference to the attached drawings.

### BRIEF DESCRIPTION OF THE DRAWINGS

FIG. 1 is a configuration diagram of an inspection system including an inspection apparatus according to an embodiment of the present disclosure.

FIG. 2 is a block diagram schematically illustrating a configuration of software modules in the inspection apparatus in FIG. 1.

FIG. 3 is a flowchart illustrating a procedure for an inspection process executed by the inspection apparatus in FIG. 1.

FIG. 4 is a diagram illustrating an example of a result display screen displayed on a user interface (UI) panel in FIG. 1.

FIG. 5 is a flowchart illustrating an example of a procedure for a defect detection process in step S305 in FIG. 3.

FIGS. 6A and 6B are diagrams illustrating examples of a filter used in step S503 in FIG. 5.

FIG. 7 is a flowchart illustrating an example of a procedure for an alignment process in step S501 in FIG. 5.

FIG. 8 is a diagram illustrating examples of images used in the alignment process in FIG. 7.

FIGS. 9A and 9B are diagrams illustrating examples of control points used in the alignment process in FIG. 7.

FIG. 10 is a diagram illustrating an example of updating positions of the control points according to the embodiment.

FIG. 11 is a diagram illustrating an example of updating the positions of the control points according to the embodiment.

FIG. 12 is a diagram illustrating an example of updating the positions of the control points according to the embodiment.

FIG. 13 is a flowchart illustrating an example of another procedure for the alignment process in step S501 in FIG. 5.

FIG. 14 is a diagram illustrating an example of a concept of the embodiment.

### DESCRIPTION OF THE EMBODIMENTS

Hereinafter, embodiments of the present disclosure will be described in detail with reference to the drawings. The following embodiments are not intended to limit the disclosure according to the claims. The embodiments include a plurality of features as described below. However, all of the features are not essential to the disclosure, and the features may be combined as appropriate. In the drawings, the same or similar components are denoted by the same reference numerals, and duplicated description thereof will be omitted.

### Apparatuses

A first embodiment of the present disclosure will be described in detail with reference to the drawings.

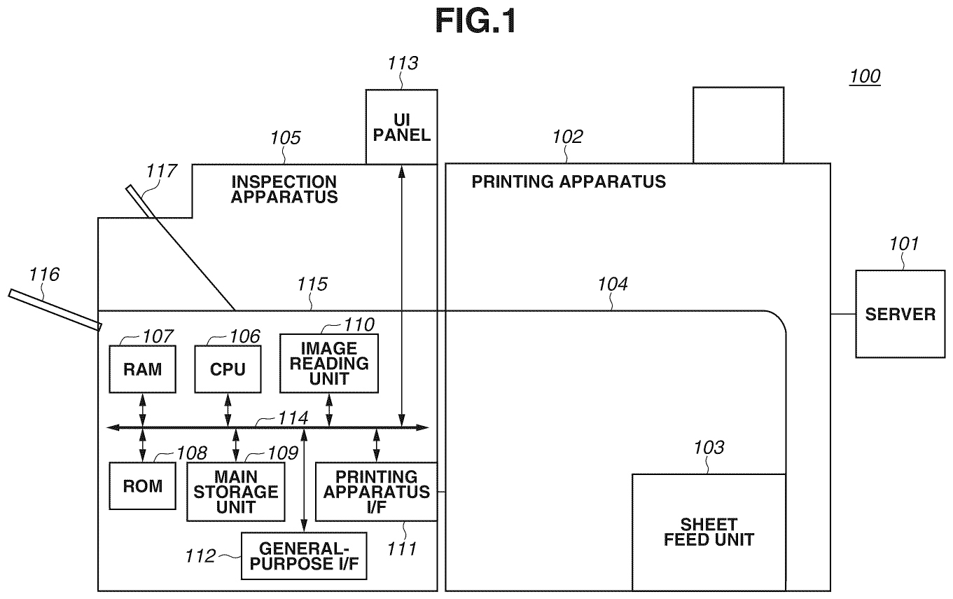

FIG. 1 illustrates a configuration of an inspection system 100 including an inspection apparatus 105 according to the present embodiment. Referring to FIG. 1, the inspection system 100 includes a server 101, a printing apparatus 102, and the inspection apparatus 105. In the inspection system 100, the printing apparatus 102 outputs a print product based on print job data generated by the server 101, and the inspection apparatus 105 inspects the print product for the presence or absence of defects.

The server 101 generates print job data and transmits the generated print job data to the printing apparatus 102. The server 101 is communicably connected to a plurality of external apparatuses (not illustrated) via a network. The server 101 receives requests, such as a request for generating print job data, from these external apparatuses.

The printing apparatus 102 forms an image on a sheet based on the print job data received from the server 101. In the present embodiment, the printing apparatus 102 is configured to use an electrophotographic printing method. However, the present embodiment is not limited thereto. The printing apparatus 102 may be configured to use another printing method such as offset printing or inkjet printing. The printing apparatus 102 includes a sheet feed unit 103. Sheets are placed in advance by the user in the sheet feed unit 103. Based on the print job data received from the server 101, the printing apparatus 102 conveys the sheets placed in the sheet feed unit 103 one by one to a conveyance path 104, forms an image on one side or both sides of the sheet, and outputs the sheet with the image formed thereon, i.e., a print product to the inspection apparatus 105.

The inspection apparatus 105 includes a central processing unit (CPU) 106, a random access memory (RAM) 107, a read only memory (ROM) 108, a main storage unit 109, an image reading unit 110, a printing apparatus interface (I/F) 111, a general-purpose I/F 112, and a user interface (UI) panel 113. The CPU 106, the RAM 107, the ROM 108, the main storage unit 109, the image reading unit 110, the printing apparatus I/F 111, the general-purpose I/F 112, and the UI panel 113 are connected together via a main bus 114. The inspection apparatus 105 also includes a conveyance path 115 connected to the conveyance path 104 in the printing apparatus 102, and output trays 116 and 117.

The CPU 106 is a processor that controls an entire operation of the inspection apparatus 105. The RAM 107 functions as a main memory or a work area for the CPU 106. The ROM 108 stores a plurality of programs to be executed by the CPU 106. The main storage unit 109 stores applications to be executed by the CPU 106, data for use in image processing, and the like. The image reading unit 110 reads one side or both sides of a print product, which is an inspection target, output from the printing apparatus 102, and generates a scanned image of the print product. More specifically, the image reading unit 110 uses at least one reading sensor (not illustrated) provided near the conveyance path 115 to read one side or both sides of the print product being conveyed. The reading sensor may be provided only at a position corresponding to one side of the print product being conveyed, or may be provided at positions corresponding to both front and back sides of the print product being conveyed in order to simultaneously read both sides of the print product. In a configuration in which the reading sensor is provided only at the position corresponding to one side of the print product, the print product of which one side has been read is conveyed to a duplex conveyance path (not illustrated) in the conveyance path 115 and the print product is turned inside out, so that the reading sensor reads the other side.

The printing apparatus I/F 111 is connected to the printing apparatus 102 to synchronize processing timing of the print product between the printing apparatus 102 and the inspection apparatus 105, and also exchange operation status information with the printing apparatus 102. The general-purpose I/F 112 is a serial bus interface such as a Universal Serial Bus (USB) interface or Institute of Electrical and Electronics Engineers (IEEE) 1394 interface. For example, the user can connect a USB memory to the general-purpose I/F 112 to write data, such as a log, stored in the main storage unit 109 into the USB memory and carry the data, or to import data from the USB memory into the inspection apparatus 105. The UI panel 113 is a liquid crystal display (a display unit), for example. The UI panel 113 functions as a user interface of the inspection apparatus 105, and displays and presents the current status and settings to the user. The UI panel 113 is a touch panel-type liquid crystal display that can receive instructions from the user operating buttons displayed thereon.

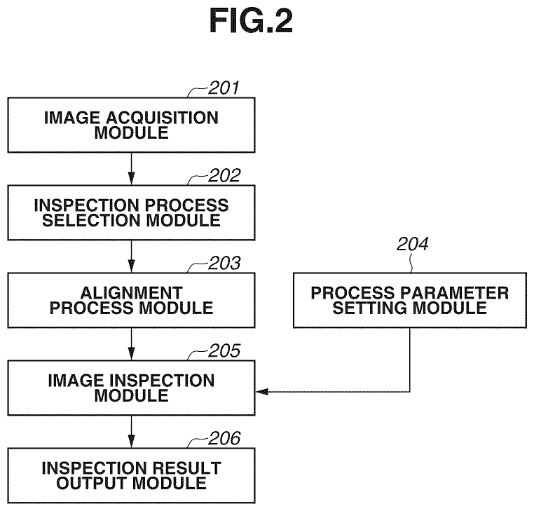

In the inspection apparatus 105, the image reading unit 110 reads the print product, serving as the inspection target, output from the printing apparatus 102 and generates a scanned image of the print product (hereinafter referred to as an “inspection target image”). In the inspection apparatus 105, an image inspection module 205 in FIG. 2 (described below) compares the inspection target image with a reference image that is registered in advance as a correct answer image, thereby inspecting the print product for the presence or absence of defects. The defects in the print product include smudges due to color materials, such as ink or toner, adhering to unintended places, and color losses where the colors appear lighter than intended because insufficient color materials adhere to the places where the image is supposed to be formed. These defects deteriorate the quality of the print product. The inspection apparatus 105 outputs the print product having passed the inspection to the output tray 116, and outputs the print product having failed the inspection to the output tray 117. In this manner, only the print products for which a certain level of quality is assured can be collected on the output tray 116 as final products to be delivered.

### Modules

FIG. 2 is a block diagram schematically illustrating a configuration of software modules in the inspection apparatus 105 in FIG. 1. The inspection apparatus 105 includes, as the software modules, an image acquisition module 201, an inspection process selection module 202, an alignment process module 203, and a process parameter setting module 204. The inspection apparatus 105 also includes the image inspection module 205 and an inspection result output module 206. The processes performed by the above-described modules are implemented by the CPU 106 loading programs from the ROM 108 into the RAM 107 and executing the programs.

The image acquisition module 201 acquires an inspection target image from the image reading unit 110. The image acquisition module 201 also acquires a reference image registered in advance as a correct answer image from the RAM 107 or the main storage unit 109. The inspection process selection module 202 selects a defect detection process based on information input by the user on a selection screen (not illustrated) displayed on the UI panel 113. On the selection screen, the user selects a defect type, for example. The inspection process selection module 202 selects a defect detection process for detecting the selected defect type from among a plurality of defect detection processes executable by the image inspection module 205. Examples of types of defects include a dot defect and a linear (streak) defect. The types of defects are not limited thereto and may include any type of defect such as image unevenness or a surficial defect. If no defect type is selected by the user, the inspection process selection module 202 selects the defect detection process set by default.

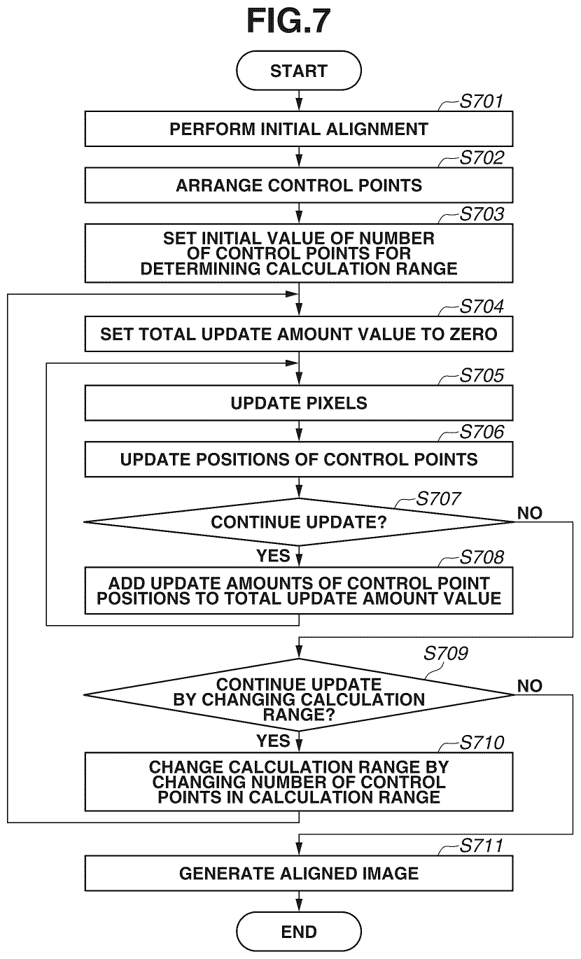

The alignment process module 203 executes an alignment process illustrated in FIG. 7 (described below) in which alignment between the inspection target image and the reference image is performed. The process parameter setting module 204 sets parameters for use in the defect detection process selected by the inspection process selection module 202. The parameters include a filter for enhancing the defect type selected by the user and a defect determination threshold for determining the defect. The image inspection module 205 executes the defect detection process selected by the inspection process selection module 202. The inspection result output module 206 displays a result of the inspection on the UI panel 113. The above-described display and the below-described display on the UI panel 113 may be presented on a display unit of another image forming apparatus or a personal computer (PC) (not illustrated) connected via a network.

### Inspection Process Procedure

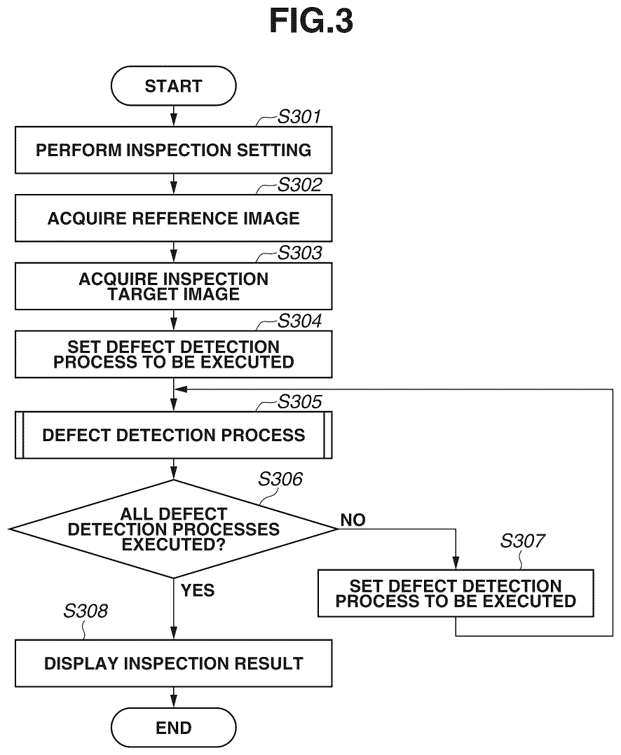

FIG. 3 is a flowchart illustrating a procedure for an inspection process executed by the inspection apparatus 105 in FIG. 1. The inspection process in FIG. 3 is implemented by the CPU 106 loading a program from the ROM 108 into the RAM 107 and executing the program.

Referring to FIG. 3, in step S301, the CPU 106 performs an inspection setting for inspection of the inspection target image, based on the information input by the user on the selection screen displayed on the UI panel 113. For example, in step S301, the inspection process selection module 202 selects at least one defect detection process based on at least one type of defect selected by the user. The process parameter setting module 204 sets parameters for use in the defect detection process(es) selected by the inspection process selection module 202.

In step S302, the CPU 106 causes the image acquisition module 201 to acquire a reference image from the RAM 107 or the main storage unit 109. In step S303, the CPU 106 causes the image acquisition module 201 to acquire an inspection target image from the image reading unit 110. Alternatively, in step S303, the CPU 106 may acquire an inspection target image generated in advance by the image reading unit 110 and stored in the main storage unit 109.

In step S304, the CPU 106 sets the defect detection process to be executed among at least one defect detection process selected by the inspection process selection module 202. For example, in step S304, the CPU 106 sets the defect detection process that is registered in advance as the process to be preferentially executed, or the defect detection process corresponding to the defect type selected first by the user.

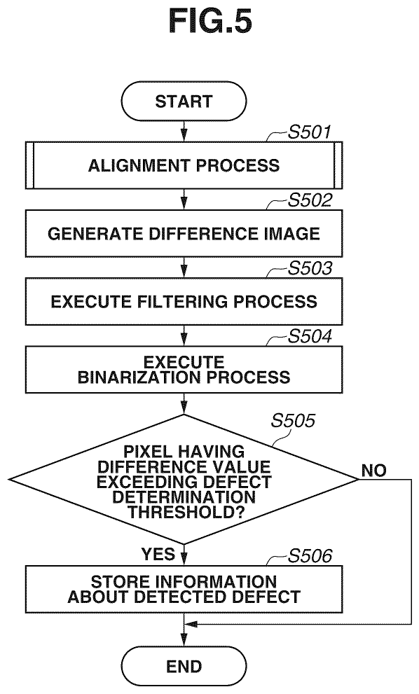

In step S305, the CPU 106 executes the defect detection process illustrated in FIG. 5 (described below). In step S306, the CPU 106 determines whether all the selected defect detection processes have been completed.

If the CPU 106 determines that any of the selected defect detection processes has not been completed (NO in step S306), then in step S307, the CPU 106 sets the defect detection process to be executed among those having not been executed, and the inspection process returns to step S305.

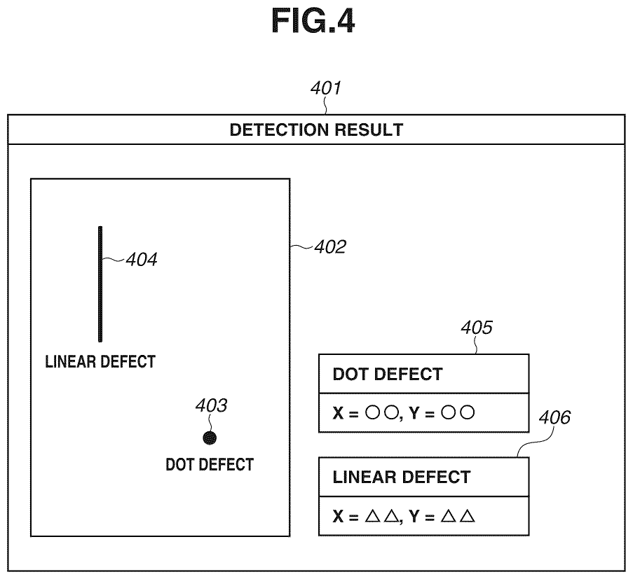

If the CPU 106 determines that all the selected defect detection processes have been completed (YES in step S306), then in step S308, the CPU 106 causes the inspection result output module 206 to display, on the UI panel 113, a result display screen 401 illustrated in FIG. 4 indicating the result of the inspection. An inspection target image 402 is displayed on the result display screen 401. For example, the text “dot defect” is displayed near a defect 403 that has been identified as a dot defect. The text “linear defect” is displayed near a defect 404 that has been identified as a linear defect. As indicated in areas 405 and 406, the coordinates of the defects in the inspection target image 402 are also displayed. A method for displaying the inspection result is not limited thereto and may be any display method, such as displaying each type of defect in a different color, as long as the method enables the user to recognize which of a plurality of defect detection processes is executed to detect each defect. Upon completion of step S308, the inspection process is ended.

### Defect Detection Process

FIG. 5 is a flowchart illustrating an example of a procedure for the defect detection process in step S305 in FIG. 3.

Referring to FIG. 5, in step S501, the CPU 106 causes the alignment process module 203 to execute an alignment process illustrated in FIG. 7 (described below) to perform alignment between the inspection target image and the reference image. In step S502, the CPU 106 causes the image inspection module 205 to compare the aligned inspection target image and the reference image to generate a difference image. The difference image is, for example, an image generated by comparing the reference image and the inspection target image on a pixel-by-pixel basis and acquiring pixel value information, for example, differences in RGB density values on a pixel-by-pixel basis.

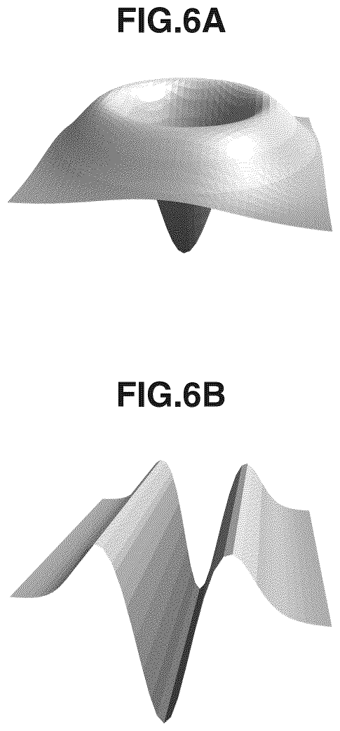

In step S503, the CPU 106 causes the image inspection module 205 to execute a filtering process for enhancing a specific shape on the difference image. For example, FIG. 6A illustrates a filter for enhancing dot defects, and FIG. 6B illustrates a filter for enhancing linear defects in a sub-scanning direction. These filters are used depending on the type of the defect detection process set in step S304 or S307. For example, if the defect detection process set in step S304 or S307 is the defect detection process for detecting dot defects, the filter illustrated in FIG. 6A is used to execute the filtering process in step S503.

If the defect detection process set in step S304 or S307 is the defect detection process for detecting linear defects in the sub-scanning direction, the filter illustrated in FIG. 6B is used to execute the filtering process in step S503.

In step S504, the CPU 106 causes the image inspection module 205 to execute a binarization process on the difference image subjected to the filtering process. Accordingly, an image (hereinafter referred to as a “binarized difference image”) is generated in which a pixel having a difference value exceeding the defect determination threshold has a pixel value of “1” and a pixel having a difference value equal to or lower than the defect determination threshold has a pixel value of “0”. In step S505, the CPU 106 causes the image inspection module 205 to use the binarized difference image to determine whether there is a pixel having a difference value exceeding the defect determination threshold.

If determining that there is no pixel having a difference value exceeding the defect determination threshold (NO in step S505), the CPU 106 determines that there is no defect and ends the defect detection process. If determining that there is a pixel having a difference value exceeding the defect determination threshold (YES in step S505), then in step S506, the CPU 106 causes the image inspection module 205 to store information about a detected defect in the RAM 107 or the main storage unit 109. More specifically, the CPU 106 causes the image inspection module 205 to store the type of the defect detection process in which the defect has been detected, and the coordinates of the defect in the RAM 107 or the main storage unit 109 in association with each other. The defect detection process is then ended.

The defect detection process in FIG. 5 is a sub-routine in step S305 and indicates a procedure for one defect detection process. Thus, each time the sub-routine in step S305 is invoked, the defect detection process of the selected type is executed. In step S503, the filter corresponding to the defect detection process of the selected type is used to execute the filtering process.

In the present embodiment, the defect detection process for detecting dot defects and the defect detection process for detecting linear defects have been described as examples of the defect detection processes. However, the types of defect detection processes are not limited thereto. In other words, in the present embodiment, any defect detection process in which a defect desired by the user is detectable can be applied, and the types of defect detection processes are not particularly limited.

### Alignment Process

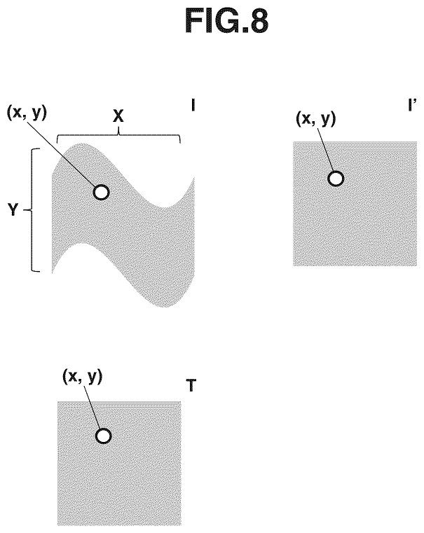

FIG. 7 is a flowchart illustrating an example of a procedure for the alignment process in step S501 in FIG. 5. In the present embodiment, an example illustrated in FIG. 8 will be described in which an inspection target image I is aligned with a reference image T to generate an aligned inspection target image (hereinafter referred to as an “aligned image”) I′. In the following description, I(x,y), T(x,y), and I′(x,y) represent pixel values in coordinates (x,y).

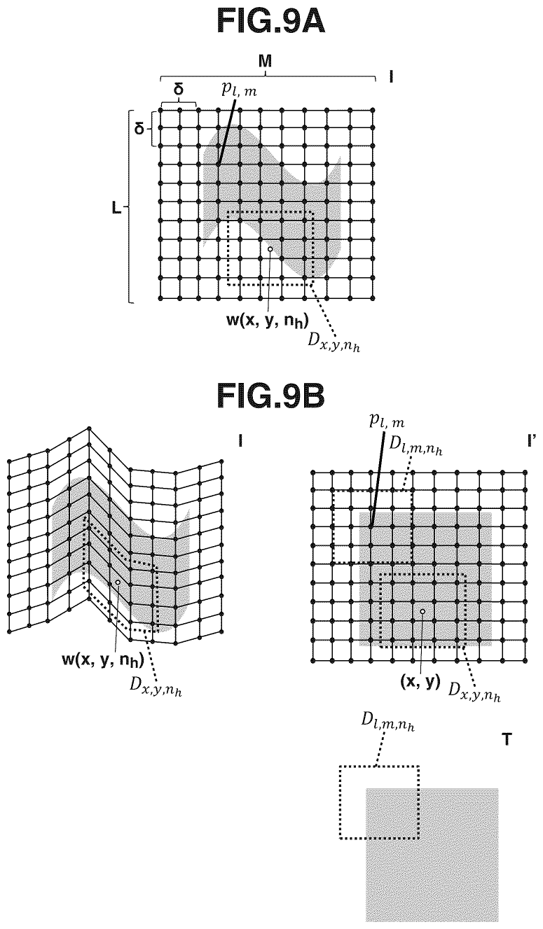

Referring to FIG. 7, in step S701, the alignment process module 203 performs initial alignment. For example, this step uses an alignment technique in which control points are extracted and projection transformation is performed so that the total sum of Euclidean distances between the control points become minimum. In step S702, the alignment process module 203 (a control point arrangement unit) arranges control points. In this step, as illustrated in FIG. 9A, the alignment process module 203 arranges L×M control points in a grid form on the inspection target image I (the scanned image of the print product). A distance δ between the control points is calculated based on the values of L and M and the image size. The coordinates of the control point in the l-th row and the m-th column are set as p_{l,m} (l=1 to L, m=1 to M).

In step S703, the alignment process module 203 sets the initial value of the number nₕ of control points for use in coordinate calculation, which is the value for determining a calculation range (described below). This value is set to be as large as possible for a reason to be described below. This is an example of setting the initial value for the calculation range.

In step S704, the alignment process module 203 sets the total value of update amounts, which is used to store amounts by which the control points are updated, to zero.

The alignment process module 203 repeats steps S705 to S708 (described below) to update the positions of the control points. The alignment process module 203 is an example of an update unit.

In step S705, the alignment process module 203 updates the pixels by using the initial value of the number nₕ of control points in FIG. 9A or using the control points updated in a control point position update process (step S706 described below) as illustrated in the inspection target image I in FIG. 9B. The update is performed using the following equation (1):

I′(x,y)=I(w(x,y,nₕ)) (1)

In the equation (1), w(x,y,nₕ) is a conversion equation for calculating the coordinates in the inspection target image I corresponding to the coordinates (x,y) in the aligned image I′. In the present embodiment, as the conversion equation, a free-form deformation (FFD) technique with a third B-spline is used. The range Dx,y,nₕ in FIG. 9A or 9B is the range of control points used to determine the coordinates w(x,y,nₕ), and nₕ is the number of control points included in the range Dx,y,nₕ. While 16 control points near the coordinates (x,y) are used in the general FFD with a third B-spline, the number nₕ of control points equal to or larger than 16 is used in the present embodiment, whereby the alignment is performed more globally than usual by using information about the pattern in a wider range at the time of updating the positions of the control points (described below). A method for determining the range Dx,y,nₕ using the number nₕ of control points is that the argument to the B -spline function is divided by 16/nₕ to extend or reduce the function, thereby controlling the range in which the B-spline takes a value larger than 0.

In step S706, the alignment process module 203 updates the positions of the control points. The update is performed using the following equation (2):

$${p}_{l , m} = {p}_{il , m} + μ \frac{∇ c}{‖ ∇ c ‖} \qquad ( 2 )$$

In the equation (2), μ denotes a weight coefficient, which may have a value such as 0.1 or may depend on the speed of updating the control points, and ∇_{c} is expressed by the following equation (3):

$$∇ c = \frac{\partial }{\partial {p}_{l , m}} {\sum }_{{D}_{l , m , {n}_{h}}} {\vert {I}^{′} ( x , y ) - T ( x , y ) \vert}^{2} \qquad ( 3 )$$

In the equation (3), ∇_{c} is the differential value of the sum of square of differences in pixel value between the aligned image I′ and the reference image T in the range Dl,m,nₕ of pixels near the control point at the coordinates p_{l,m} in the aligned image I′ in FIG. 9B. In the present embodiment, the range Dl,m,nₕ is the range of pixels near the control point at the coordinates p_{l,m} in which the B-spline takes a value larger than 0. The range Dl,m,nₕ is controlled by the number nₕ of control points, similarly to the range Dx,y,nₕ. As indicated by the control points arranged in the inspection target image I in FIG. 9B, the control points are to be moved in shift directions with reference to the reference image T. Thus, ∇_{c} in the equation (3) can be regarded as determining the directions of the shifts of the pixels in the range Dl,m,nₕ and calculating the sum of the directions. The differential equation δI′(x,y)/δw(x,y) in the following equation (4) obtained by expanding the equation (3) takes a value other than 0 when the position (x,y) in the aligned image I′ is at the edge of the pattern.

$$∇ c = 2 {\sum }_{{D}_{l , m , {n}_{h}}} ( {I}^{′} ( x , y ) - T ( x , y ) ) \frac{\partial {I}^{′} ( x , y )}{\partial w ( x , y )} \frac{\partial w ( x , y )}{\partial {p}_{l , m}} \qquad ( 4 )$$

In other words, the equation (4) can be regarded as calculating the directions of the shifts of the pixels at the edge of the pattern in the range Dl,m,nₕ.

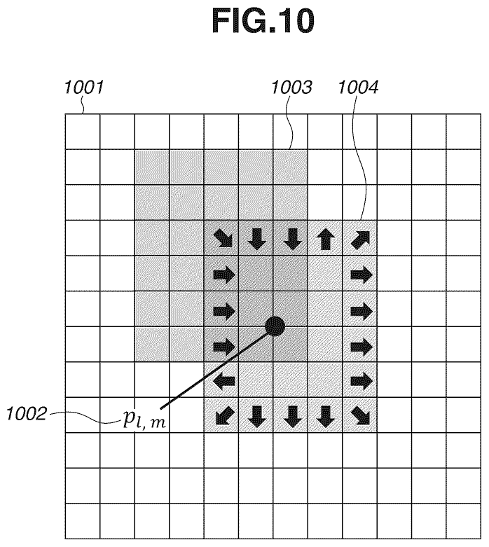

FIG. 10 schematically illustrates the directions of the shifts of the pixels in the aligned image I′, which are calculated using the equation (4), with arrows. A range 1001 represents the range Dl,m,nₕ with respect to a control point 1002, and patterns 1003 and 1004 represent patterns in the reference image T and the aligned image I′, respectively. The pattern 1004 partially overlaps the pattern 1003. The directions of the shifts of the pixels in the portion of the edge of the pattern 1004 that overlaps the pattern 1003 can be correctly calculated. The pixels in the non-overlapping portion can also be determined as being shifted in the direction from the inside to the outside of the edge. As a result, when the sum of the directions of the shifts is calculated, it can be seen that the pattern 1004 is entirely shifted in the lower right direction.

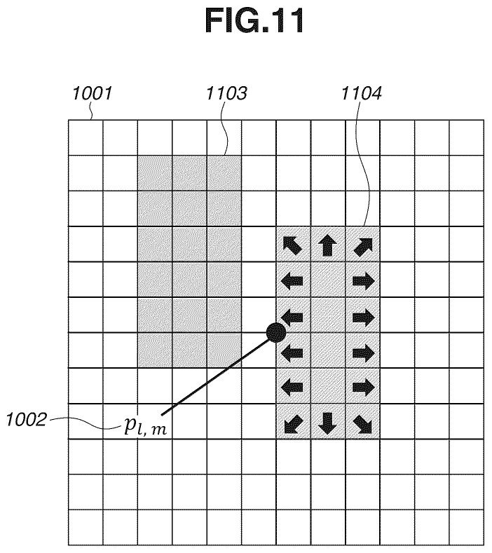

However, if the positions of patterns do not overlap due to large shifts or a small pattern size as in the case of patterns 1103 and 1104 in FIG. 11, it is determined that all the pixels at the edge are shifted from the inside to the outside, in other words, it is determined that the pattern 1103 is within the pattern 1104. As a result, when the sum of the directions of the shifts is calculated, the shifts are canceled. Thus, if the positions of certain patterns do not overlap, it is not possible to determine the directions of the shifts only based on the positional relationship between these patterns.

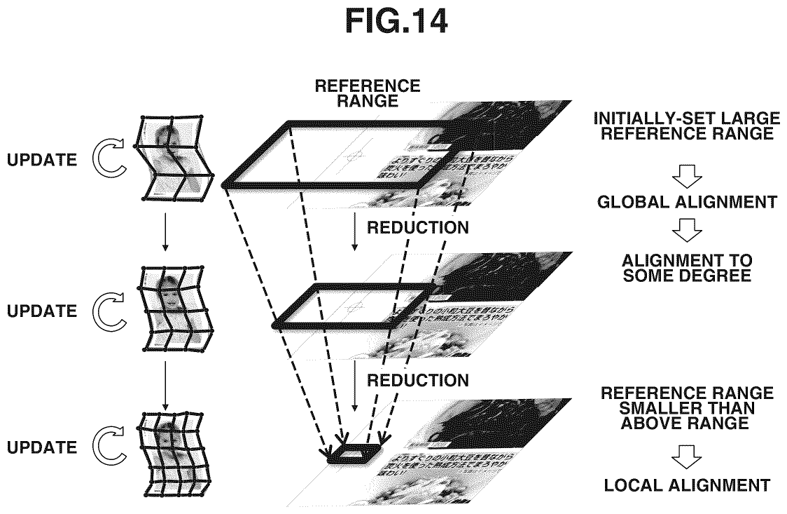

Next, a concept of the present embodiment will be described with reference to FIG. 14. As illustrated in FIG. 14, a relatively large range is initially set as a range of interest, i.e., a calculation target range. Then, the control points are updated for global alignment. After that, the control points are updated while the range of interest is narrowed stepwise, thereby making a transition to local alignment. Accordingly, even if the positions of certain patterns do not overlap in the range of interest, it is possible to improve the accuracy of the alignment. An example of implementation will be described below.

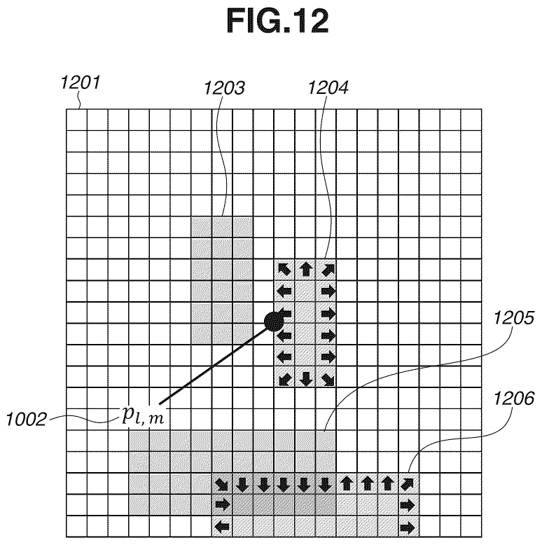

According to the present embodiment, in updating the control points, the range Dl,m,nₕ of pixels for use in calculation is initially set to a wide range. This is an example of a first range of interest, and will be described with reference to FIG. 12. If the range Dl,m,nₕ is set to a wide range such as a range 1201, overlapping patterns such as patterns 1205 and 1206 in the reference image T and the aligned image I′, respectively, are likely to fall within the calculation range. Accordingly, the directions of the shifts around the control points can be globally determined. In the present embodiment, in step S703, the range Dl,m,nₕ is set to a wide range by increasing the initial value of the number nₕ of control points for use in coordinate calculation.

In step S707, the alignment process module 203 determines whether to continue updating the positions of the pixels and the control points. In the present embodiment, this determination is made based on whether the maximum value of update amounts of the positions of all the control points is equal to or greater than a threshold. If the maximum value is equal to or greater than the threshold (YES in step S707), it can be determined that the control points still have room for moving, and thus the update is continued. If the maximum value is smaller than the threshold (NO in step S707), it can be determined that the control points can no longer move even when the positions are further updated, and thus the update is ended. Alternatively, the update may be continued the number of times specified in advance by the user.

If the update is determined to be continued, then in step S708, the alignment process module 203 adds the update amounts of all the control points to the total value of the update amounts. Then, the process returns to step S705 to update the pixels.

Upon completion of the update, in step S709, the alignment process module 203 (an update continuation unit) determines whether to change the calculation range (described below), based on whether the total value of the update amounts is equal to or greater than a threshold. If the total value is equal to or greater than the threshold (YES in step S709), the alignment process module 203 determines that there is still room for the update, and the process proceeds to step S710 to change the calculation range. If the total value is smaller than the threshold (NO in step S709), the alignment process module 203 determines that there is no longer room for the update, and does not change the calculation range. In this case, in step S711, the alignment process module 203 generates an aligned image using the updated control points, and the alignment process is ended.

In step S710, the alignment process module 203 (a calculation range change unit) narrows the range Dx,y,nₕ and the range Dl,m,nₕ in updating the pixels and the control points. In other words, this is an example of a second range of interest different from the first range of interest. If the calculation range is increased, a global positional shift can be determined, but the directions of local positional shifts near the control points are unable to be determined. On the other hand, narrowing the calculation range makes it possible to determine local positional shifts. Thus, in the present embodiment, first, global alignment is performed in a wide calculation range, so that patterns not overlapping are aligned to some degree. Next, the calculation range is narrowed to determine local positional shifts.

The wide calculation range is an example of the first range of interest with a first size, and the narrowed calculation range is an example of the second range of interest with a second size smaller than the first size.

However, if the calculation range is rapidly narrowed, insufficiently overlapping patterns are unable to be aligned. Thus, changing the calculation range and updating the control points are repeatedly performed to gradually narrow the calculation range. Accordingly, a gradual transition from global alignment to local alignment is made with increased accuracy. In the present embodiment, the calculation range is controlled by the number nₕ of control points. For example, each time the calculation range is changed, the number nₕ of control points is decreased to one fourth to halve one side of the calculation range. However, if the number nₕ of control points is 16, the calculation range is not changed. The process then returns to step S704 to set the total value of the update amounts to zero. The initial wide calculation range is an example of the first range of interest with the first size. The gradually narrowed calculation range is an example of the second range of interest with the second size smaller than the first size.

According to the above-described embodiment, first, a wide calculation range is set as an initial value to update the control points, so that global alignment is performed. Then, changing the calculation range to halve one side of the calculation range, and updating the control points are repeatedly performed. Accordingly, a gradual transition from global alignment to local alignment is made with increased accuracy. As a result, even if there are patterns not overlapping, a gradual transition from global alignment to local alignment is made, thereby enabling high-accuracy alignment.

In the above-described embodiment, whether to change the calculation range is determined based on whether the total value of the update amounts is equal to or greater than the threshold. However, because the calculation time is longer than that in general free-form alignment not involving changing the calculation range, the calculation range may be changed the number of times specified in advance by the user. For example, if the number of times of changing the calculation range is set to zero, the same alignment process as that in the general free-form alignment not involving changing the calculation range is performed, for example.

In the above-described embodiment, a case has been described where the number nₕ of control points is used as the value for determining the calculation range. However, the wider the calculation range, the longer the calculation time. In one or more embodiments, the calculation range can be determined by changing the number L×M of control points arranged on the inspection target image I (the scanned image of the print product). The calculation time taken to update the positions of the control points can be shortened by making the number of control points small at the initial stage.

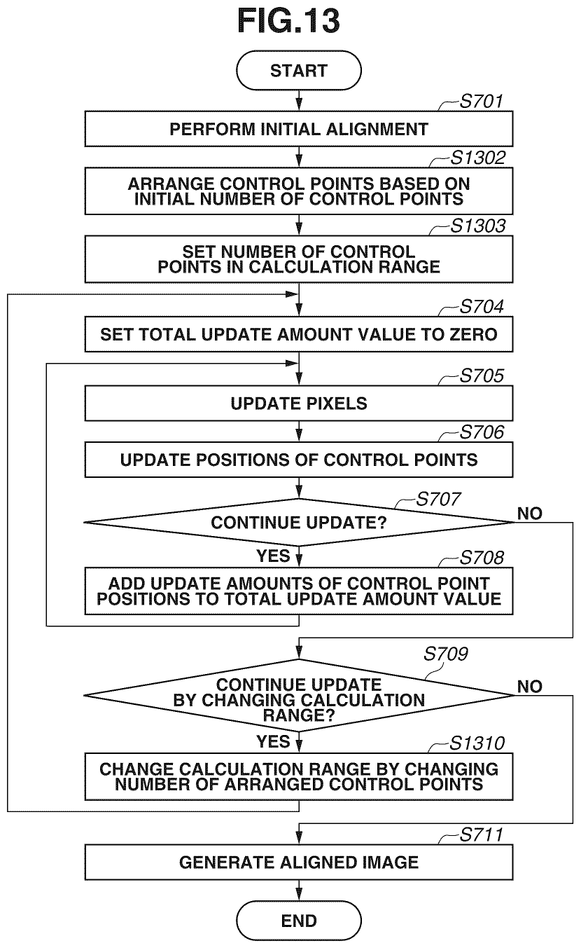

FIG. 13 is a flowchart illustrating an example of another procedure for the alignment process in step S501 in FIG. 5. The alignment process in FIG. 13 is a process similar to the alignment process in FIG. 7. Differences from the alignment process in FIG. 7 will thus be described.

In step S1302, the alignment process module 203 (an initial calculation range value setting unit) arranges Lₕ×Mₕ control points in a grid form on the inspection target image I (the scanned image of the print product). In step S1303, the alignment process module 203 sets the number nₕ (e.g., 16) of control points for use in coordinate calculation.

In step S1310, the alignment process module 203 (the calculation range change unit) changes the calculation range by changing the number Lₕ×Mₕ of control points arranged on the inspection target image I. Changing the number Lₕ×Mₕ of control points arranged on the inspection target image I changes the spacings between the control points. Thus, the calculation range can be changed even if the number nₕ of control points in the calculation range is fixed.

For example, each time this step is performed, each of the numbers Lₕ and Mₕ of control points is increased twice to halve one side of the calculation range. However, when the numbers Lₕ and Mₕ of control points are increased, the arrangement of the control points before the increase is to be carried on. Thus, the arrangement of the control points after the increase is determined using the following procedure. First, equally spaced grid points as many as the control points after the increase are prepared. Next, the grid points are moved using the control points before the increase. Then, the positions of the control points after the increase are calculated using z transformation or the like, based on the positions of the grid points before and after the movement.

According to the present embodiment, even if there are patterns not overlapping, a gradual transition from global alignment to local alignment is made, thereby enabling high-accuracy alignment. Further, in the present embodiment, the number of control points can be made small at the initial stage, so that it is possible to shorten the calculation time taken to update the positions of the control points.

As described above, the present embodiment discusses an inspection system that inspects an inspection target image (an inspection image) using a reference image and the inspection image. The inspection system 100 is an example of the inspection system.

As described above, the CPU 106 performs alignment between the reference image and the inspection image by sequentially using a plurality of ranges of interest that is different in size. Then, the CPU 106 inspects the reference image and the inspection image by performing the alignment.

The plurality of ranges of interest includes a first range of interest with a first size and a second range of interest with a second size smaller than the first size. The CPU 106 performs first alignment using the first range of interest. The CPU 106 further performs second alignment using the second range of interest after the first alignment. The CPU 106 performs the first alignment by updating positions of control points in the first range of interest. The CPU 106 performs the second alignment by updating positions of control points in the second range of interest after the first alignment. The control points are arranged in a grid form on the reference image and the inspection image. The CPU 106 updates the positions of the control points based on non-rigid deformation rules.

The image reading unit 110 has been described as an example of a reading unit that reads a print medium (a print product) to generate a scanned image of the print product. Examples of print media include paper, an electronic circuit board, a wood plate, and a plastic plate. The materials of print media are not limited to paper, and the shapes thereof are not limited to the square shape. Examples of print media also include a compact disc (CD) and a digital versatile disc (DVD). Print media may be any media on which patterns and/or characters are printed using an electrophotographic technique, an inkjet technique, or any other printing technique. The CPU 106 may set the scanned image as the inspection image and align the inspection image with the reference image.

The CPU 106 may perform the inspection based on the aligned image obtained by the CPU 106 and the reference image. The inspection may be performed by a CPU of another apparatus.

The CPU 106 sets, as the range of interest, an image range that is a calculation target range (a calculation range) in updating the positions of the plurality of control points. The CPU 106 performs (1) updating the positions of the plurality of control points in the range of interest, and (2) reducing the range of interest while maintaining the plurality of control points whose positions are updated.

The inspection system 100 may also have a mechanism that generates an aligned scanned image based on a plurality of control points including control points whose positions are updated by repeating the above (1) and (2). The CPU 106 may repeat the above (1) and (2) the number of times specified in advance by the user.

An embodiment of the present disclosure may be applied to a system including a plurality of devices such as a host computer, an interface device, a reader, and a printer, or may be applied to a single apparatus such as a copying machine or a facsimile machine.

According to an aspect of the present disclosure, it is possible to improve the accuracy of inspection of output results in a print process.

According to another aspect of the present disclosure, it is possible to provide a mechanism that enables alignment between a reference image and an inspection target image even if it is difficult to use a pattern or characters for the alignment between the images.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of priority from Japanese Patent Application No. 2022-157627, filed Sep. 30, 2022, which is hereby incorporated by reference herein in its entirety.

What is claimed is:

1. An inspection system that inspects an inspection image using a reference image, the inspection system comprising:
an alignment unit configured to perform alignment between the reference image and the inspection image by sequentially using a plurality of ranges of interest that are different in size; and
an inspection unit configured to inspect the reference image and the inspection image based on the alignment performed by the alignment unit.

2. The inspection system according to claim 1,
wherein the plurality of ranges of interest include a first range of interest with a first size and a second range of interest with a second size smaller than the first size, and
wherein the alignment unit performs first alignment using the first range of interest, and further performs second alignment using the second range of interest after the first alignment.

3. The inspection system according to claim 2, wherein the alignment unit performs the first alignment by updating positions of control points in the first range of interest, and performs the second alignment by updating positions of control points in the second range of interest after the first alignment.

4. The inspection system according to claim 3,
wherein the control points are arranged in a grid form on the reference image and the inspection image, and
wherein the positions of the control points are updated based on a non-rigid deformation rule.

5. The inspection system according to claim 1, further comprising a reading unit configured to read a print product to generate a scanned image of the print product,
wherein the alignment unit sets the scanned image as the inspection image and aligns the inspection image with the reference image, and
wherein the inspection unit inspects the reference image and the inspection image based on the aligned inspection image obtained by the alignment unit and the reference image.

6. The inspection system according to claim 1, further comprising a setting unit configured to set, as a range of interest, an image range that is a calculation target range in updating positions of a plurality of control points, the range of interest being included in the plurality of ranges of interest,
wherein the alignment unit further performs:
(1) updating the positions of the plurality of control points in the range of interest, and
(2) reducing the range of interest while maintaining the plurality of control points whose positions are updated, and
wherein the inspection system further comprises an aligned image generation unit configured to generate an aligned scanned image based on control points whose positions are updated by the alignment unit repeating (1) the updating and (2) the reducing.

7. The inspection system according to claim 6, wherein (1) the updating and (2) the reducing are repeated by the alignment unit a number of times specified in advance by a user.

8. A method for controlling an inspection system that inspects an inspection image using a reference image, the method comprising:
performing alignment between the reference image and the inspection image by sequentially using a plurality of ranges of interest that are different in size; and
inspecting the reference image and the inspection image by performing the alignment.

9. The method according to claim 8,
wherein the plurality of ranges of interest include a first range of interest with a first size and a second range of interest with a second size smaller than the first size, and
wherein the performing of the alignment includes performing first alignment using the first range of interest, and further performing second alignment using the second range of interest after the first alignment.

10. The method according to claim 9, wherein the performing of the alignment includes performing the first alignment by updating positions of control points in the first range of interest, and performing the second alignment by updating positions of control points in the second range of interest after the first alignment.

11. The method according to claim 10,
wherein the control points are arranged in a grid form on the reference image and the inspection image, and
wherein the positions of the control points are updated based on a non-rigid deformation rule.

12. The method according to claim 8, further comprising reading a print product to generate a scanned image of the print product,
wherein the performing of the alignment includes setting the scanned image as the inspection image and aligning the inspection image with the reference image, and
wherein the reference image and the inspection image are inspected based on the aligned inspection image and the reference image.

13. The method according to claim 8, further comprising setting, as a range of interest, an image range that is a calculation target range in updating positions of a plurality of control points, the range of interest being included in the plurality of ranges of interest,
wherein the performing of the alignment includes:
(1) updating the positions of the plurality of control points in the range of interest, and
(2) reducing the range of interest while maintaining the plurality of control points whose positions are updated, and
wherein the method further comprises generating an aligned scanned image based on control points whose positions are updated by repeating (1) the updating and (2) the reducing.

14. The method according to claim 13, wherein (1) the updating and (2) the reducing are repeated a number of times specified in advance by a user.

15. A non-transitory computer readable storage medium storing a program for causing a computer to execute a method for controlling an inspection system that inspects an inspection image using a reference image, the method comprising:
performing alignment between the reference image and the inspection image by sequentially using a plurality of ranges of interest that are different in size; and
inspecting the reference image and the inspection image by performing the alignment.
